(19) United States
(12) Patent Application Publication
(10) Pub. No.: US 2019/0035104 A1
(43) Pub. Date: Jan. 31, 2019

(54) OBJECT DETECTION AND TRACKING

(71) Applicant: Motionloft, Inc., San Francisco, CA (US)

(72) Inventors: Mark Cuban, Dallas, TX (US); Joyce Reitman, San Francisco, CA (US); Paul McAlpine, Dublin, CA (US)

(21) Appl. No.: 15/659,239

(22) Filed: Jul. 25, 2017

(51) Int. Cl. G06T 7/70; H04N 7/18; G06T 7/11; G06T 7/20; G06K 9/46; G06K 9/00

(52) U.S. Cl. CPC G06T 7/70; H04N 7/181; G06T 7/11; G06T 2207/30232; G06K 9/4604; G06K 9/00771; G06T 2207/30196; G06T 7/20

(57) ABSTRACT

An object detection system can utilize multiple detection devices, each including at least one image capture element that can capture image data for a region of interest and detect types of objects located in that region. Information such as the coordinates of the objects and descriptors for the objects can be transmitted, along with timestamp data, in order to allow those objects to be counted, tracked, or otherwise monitored by a separate system without transmitting the image data or potentially sensitive data regarding the objects. The data from multiple devices for the region can be aggregated such that objects can be tracked as the objects switch between different fields of view of different devices, based on the location and descriptor data. Information about the presence, location, or movement of certain types of actions can be used to trigger specific actions, such as to allocate resources or generated alarms based thereon.

### BACKGROUND

Entities are increasingly using digital video to monitor various locations. This can be used to monitor occurrences such as traffic congestion or the actions of people in a particular location. One downside to such an approach is that many approaches still require at least some amount of manual review, which can be expensive and prone to detection errors. In other approaches the video can be analyzed by a set of servers to attempt to detect specific information. Such an approach can be very expensive, however, as a significant amount of bandwidth is needed to transfer the video to the data center or other location for analysis. Further, the analysis is performed offline and following capture and transmission of the video data, which prevents any real-time action from being taken in response to the analysis.

### BRIEF DESCRIPTION OF THE DRAWINGS

Various embodiments in accordance with the present disclosure will be described with reference to the drawings which are described as follows.

FIG. 1 illustrates a front view of an example detection device that can be utilized in accordance with various embodiments.

FIG. 2 illustrates a perspective view of an example detection device that can be utilized in accordance with various embodiments.

FIG. 3 illustrates a top view of an example detection device that can be utilized in accordance with various embodiments.

FIG. 4 illustrates a side view of an example detection device that can be utilized in accordance with various embodiments.

FIG. 5 illustrates a back view of an example detection device that can be utilized in accordance with various embodiments.

FIG. 6 illustrates a bottom view of an example detection device that can be utilized in accordance with various embodiments.

FIG. 7 illustrates components of an example detection device that can be utilized in accordance with various embodiments.

FIG. 8 illustrates an example environment in which aspects of various embodiments can be implemented.

FIG. 9 illustrates an example translation of captured data that can be performed in accordance with various embodiments.

FIG. 10 illustrates an example approach to detecting people within the field of view of at least one camera that can be utilized in accordance with various embodiments.

FIGS. 11A and 11B illustrate an example approach to tracking the movement of objects over time that can be utilized in accordance with various embodiments.

FIG. 12 illustrates example sets of feature points that can be used to detect or recognize different types of objects that can be utilized in accordance with various embodiments.

FIGS. 13A and 13B illustrate example interfaces for providing information about detected objects that can be utilized in accordance with various embodiments.

FIG. 14 illustrates an example process for obtaining and processing data on a detection device that can be utilized in accordance with various embodiments.

FIG. 15 illustrates an example process for aggregating and analyzing information from multiple detection devices that can be utilized in accordance with various embodiments.

FIG. 16 illustrates an example process for initiating an action in response to an occurrence detected using one or more detection devices that can be utilized in accordance with various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Systems and methods in accordance with various embodiments of the present disclosure may overcome one or more of the aforementioned and other deficiencies experienced in conventional approaches to detecting physical objects. In particular, various embodiments provide mechanisms for locating objects of interest, such as people, vehicles, products, logos, fires, and other detectable objects. Various embodiments enable these items to be detected, identified, counted, tracked, monitored, and/or otherwise accounted for through the use of, for example, captured image data. The image data (or other sensor data) can be captured using one or more detection devices as described herein, among other such devices and systems. Various other functions and advantages are described and suggested below as may be provided in accordance with the various embodiments.

There can be many situations where it may be desirable to detect a presence of one or more objects of interest, such as to determine the number of objects in a given location at any time, as well as to determine patterns of motion, behavior, and other such information. This can include, for example, detecting the number of people in a given location, as well as the movement or actions of those people over a period of time. Conventional image or video analysis approaches require the captured image or video data to be transferred to a server or other remote system for analysis. As mentioned, this requires significant bandwidth and causes the data to be analyzed offline and after the transmission, which prevents actions from being initiated in response to the analysis in near real time. Further, in many instances it will be undesirable, and potentially unlawful, to collect information about the locations, movements, and actions of specific people. Thus, transmission of the video data for analysis may not be a viable solution. There are various other deficiencies to conventional approaches to such tasks as well.

Accordingly, approaches in accordance with various embodiments provide systems, devices, methods, and software, among other options, that can provide for the near real time detection and/or tracking of specific types of objects, as may include people, vehicles, products, and the like. Other types of information can be provided that can enable actions to be taken in response to the information while those actions can make an impact, and in a way that does not disclose information about the persons represented in the captured image or video data, unless otherwise instructed or permitted. Various other approaches and advantages will be appreciated by one of ordinary skill in the art in light of the teachings and suggestions contained herein.

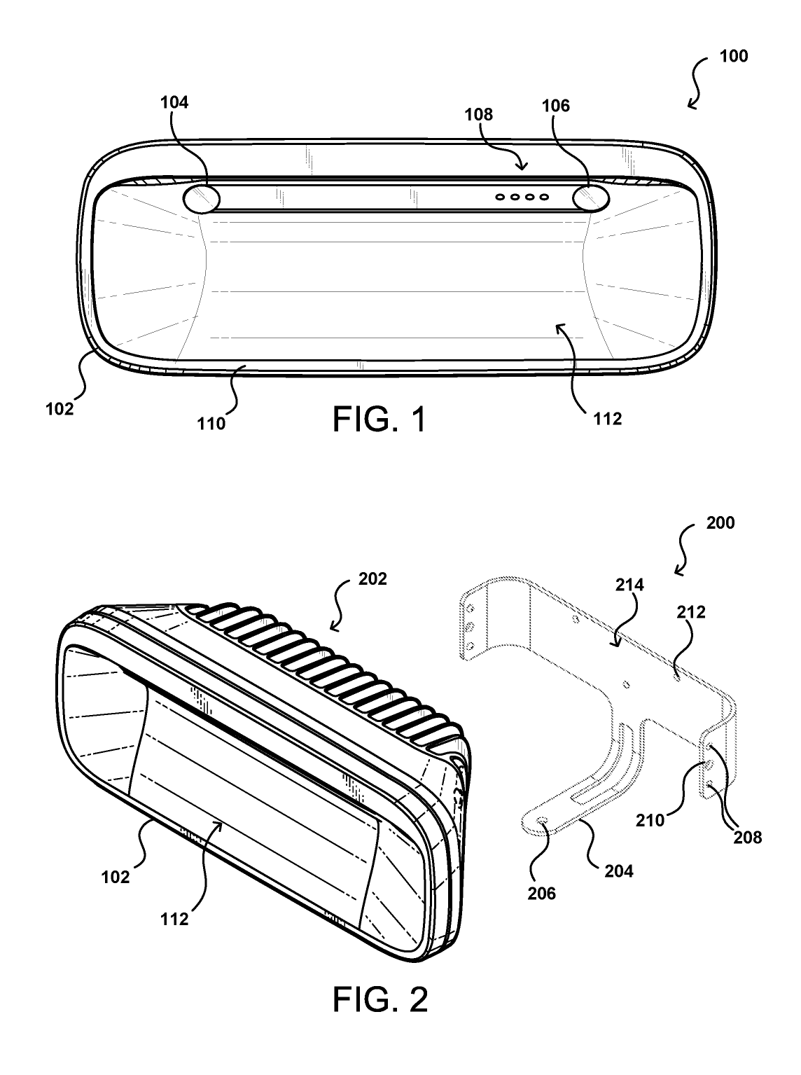

In various embodiments, a detection device 100 can be used such as that illustrated in the front view of FIG. 1. In many situations there will be more than one device positioned about an area in order to cover views of multiple partially overlapping regions, to provide for a larger capture area and multiple capture angles, among other such advantages. Each detection device can be mounted in an appropriate location, such as on a pole or wall proximate the location of interest, where the mounting can be fixed, removable, or adjustable, among other such options. As discussed elsewhere herein, an example detection device can also be mounted directly on a window or similar surface enabling the device to capture image data for light passing through the window from, for example, the exterior of a building. The detection device 100 illustrated includes a pair of cameras 104, 106 useful in capturing two sets of video data with partially overlapping fields of view which can be used to provide stereoscopic video data. The cameras 104, 106 are positioned at an angle such that when the device is positioned in a conventional orientation, with the front face 110 of the device being substantially vertical, the cameras will capture video data for items positioned in front of, and at the same height or below, the position of the cameras. As known for stereoscopic imaging and as discussed in more detail elsewhere herein, the cameras can be configured such that their separation and configuration are known for disparity determinations. Further, the cameras can be positioned or configured to have their primary optical axes substantially parallel and the cameras rectified to allow for accurate disparity determinations. It should be understood, however, that devices with a single camera or more than two cameras can be used as well within the scope of the various embodiments, and that different configurations or orientations can be used as well. Various other types of image sensors can be used as well in different devices. The device casing can have a concave region 112 or other recessed section proximate the cameras 104, 106 such that the casing does not significantly impact or limit the field of view of either camera. The shape of the casing near the camera is also designed, in at least some embodiments, to provide a sufficiently flat or planar surface surrounding the camera sensors such that the device can be placed flush against a window surface, for example, while preventing reflections from behind the sensor from entering the lenses as discussed in more detail elsewhere herein.

The example detection device 100 of FIG. 1 includes a rigid casing 102 made of a material such as plastic, aluminum, or polymer that is able to be mounted indoors or outdoors, and may be in a color such as black to minimize distraction. In other situations where it is desirable to have people be aware that they are being detected or tracked, it may be desirable to cause the device to have bright colors, flashing lights, etc. The example device 102 also has a set 108 of display lights, such as differently colored light-emitting diodes (LEDs), which can be off in a normal state to minimize power consumption and/or detectability in at least some embodiments. If required by law, at least one of the LEDs might remain illuminated, or flash illumination, while active to indicate to people that they are being monitored. The LEDs 108 can be used at appropriate times, such as during installation or configuration, trouble shooting, or calibration, for example, as well as to indicate when there is a communication error or other such problem to be indicated to an appropriate person. The number, orientation, placement, and use of these and other indicators can vary between embodiments. In one embodiment, the LEDs can provide an indication during installation of power, communication signal (e.g., LTE) connection/strength, wireless communication signal (e.g., WiFi or Bluetooth) connection/strength, and error state, among other such options.

FIG. 2 illustrates a perspective view 200 of an example detection device. This view provides perspective on a potential shape of the concave region 112 that prevents blocking a portion of the view of view of the stereo cameras as discussed with respect to FIG. 1. Further, this view illustrates that the example device includes an incorporated heat sink 202, or set of heat dissipation fins, positioned on a back surface of the detection device. The arrangement, selection, and position of the heat sink(s) can vary between embodiments, and other heat removal mechanisms such as fans can be used as well in various embodiments. The fins can be made from any appropriate material capable of transferring thermal energy from the bulk device (and thus away from the heat generating and/or sensitive components such as the processors. The material can include, for example, aluminum or an aluminum alloy, which can be the same material or a different material from that of the primary casing or housing 102. It should also be understood that the casing itself may be made from multiple materials, such as may include a plastic faceplate on an aluminum housing.

As illustrated, the housing 102 in some embodiments can also be shaped to fit within a mounting bracket 204 or other such mounting apparatus. The mounting bracket can be made of any appropriate materials, such as metal or aluminum, that is sufficiently strong to support the detection device. In this example the bracket can include various attachment mechanisms, as may include openings 206, 212 (threaded or otherwise) for attachment screws or bolts, as well as regions 204, 214 shaped to allow for mounting to a wall, pole, or tripod, among other such options. The bracket illustrated can allow for one-hand installation, such as where the bracket 204 can be screwed to a pole or wall. The detection device 202 can then be installed by placing the detection device into the mounted bracket 204 until dimples 208 extending from the bracket are received into corresponding recesses in the detection device (or vice versa) such that the detection device 202 is held in place on the bracket. This can allow for relatively easy one-handed installation of the device in the bracket, particularly useful when the installation occurs from a ladder to a bracket mounted on a pole or other such location. Once held in place, the device can be securely fastened to the bracket using one or more safety screws, or other such attachment mechanisms, fastened through corresponding openings 210 in the mounting bracket. Various other approaches for mounting the detection device in a bracket, or using a bracketless approach where the device is mounted directly to a location, can be used as well within the scope of the various embodiments. As discussed in more detail later herein, another example mounting approach involves using double-sided tape, or another such adhesive material, with a pre-cut stencil. One side of the tape can be applied to the casing of the detection device during manufacture and assembly, for example, such that when installation is to occur one can peel off or remove an outer silicone paper and press the exposed adhesive on the tape carrier material directly to a window or other light-transmissive surface. As discussed, such an approach can enable the face or lip region of the front of an example device to a window in order for the two cameras 104, 106 to capture light passing through the window glass. The adhesive will also help to form a seal such that external light does not leak into the camera region and get detected by the relevant sensors. Further, while in some embodiments the detection device will include a power cord (or port to receive a power cord), in other embodiments the bracket can function as a docking station wherein a power port on the device mates with a power connection on the bracket (or vice versa) in order to power the device. Other power sources such as battery, solar cells, or wireless charging can be used as well within the scope of the various embodiments.

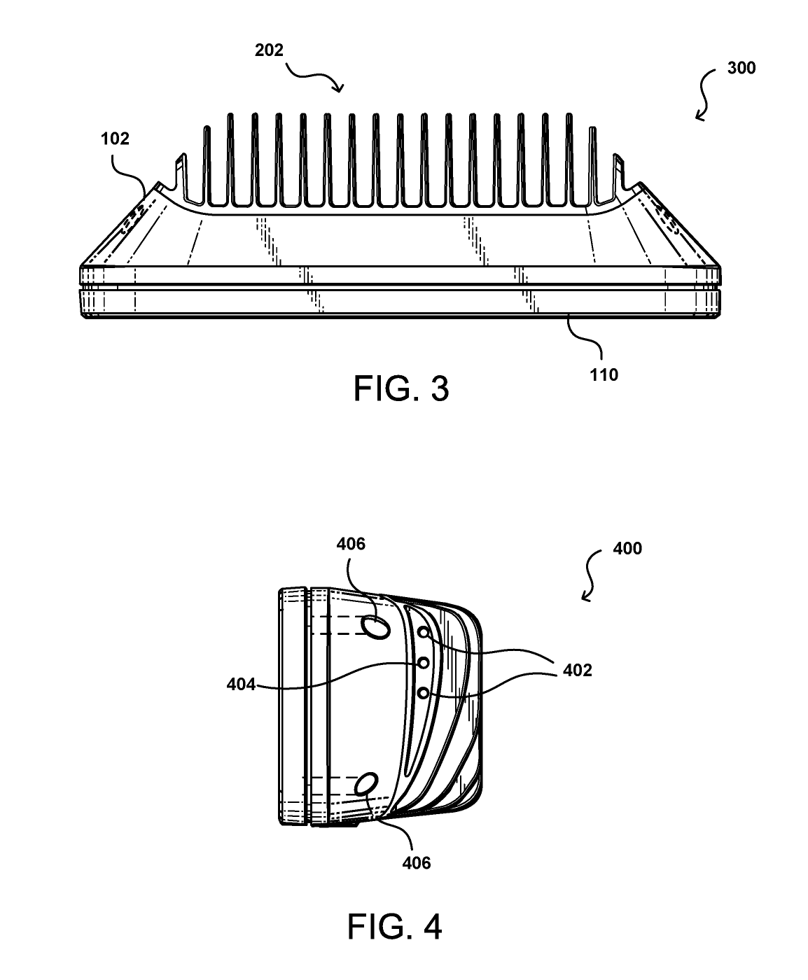

FIG. 3 illustrates a top view 300 of the detection device, showing a potential arrangement of the heat sink fins 202 relative to the device housing 102. The flat front face 110 is also illustrated in this example. The number, size, and arrangement of the fins 202 can vary based upon factors such as heat generated by the interior components, whether the device is installed indoors or outdoors, the expected ambient temperature, and other such factors. The fins also can be configured to allow for bracket or wall installation, as discussed with respect to FIG. 2. Further, the fins can be arranged on the back such that if the front face 110 is installed against a window then the fins can still provide sufficient heat removal. The flat front face can allow for installation against a window, such as where a store wants to track movement or numbers of people passing by, looking in the window, etc. Such a mounting approach can also be used for parking lot security and other such purposes, such as in situations where a store owner may have no permission from the building owner to mount external security devices, but such a detection device can be installed in the store to capture information about activities occurring in an area outside the store, such as in a parking lot or external sidewalk. The flat front can allow for attachment to the window using dual sided tape or adhesive as discussed previously, among other such options. The flat front also can prevent light from entering the device from between the device and the facing side of the window, thus preventing reflections or other light from leaking in and potentially resulting in false positives or inaccurate determinations. Further, in some embodiments unwanted light originating from behind the sensor heat sink fins could otherwise travel towards the window surface and be reflected back through the lenses of the camera sensors. This might be common in situations where, for example, the device is installed indoors on a window facing an external location, and when the in-store lighting or other light from behind the device is stronger or more intense than the external ambient light.

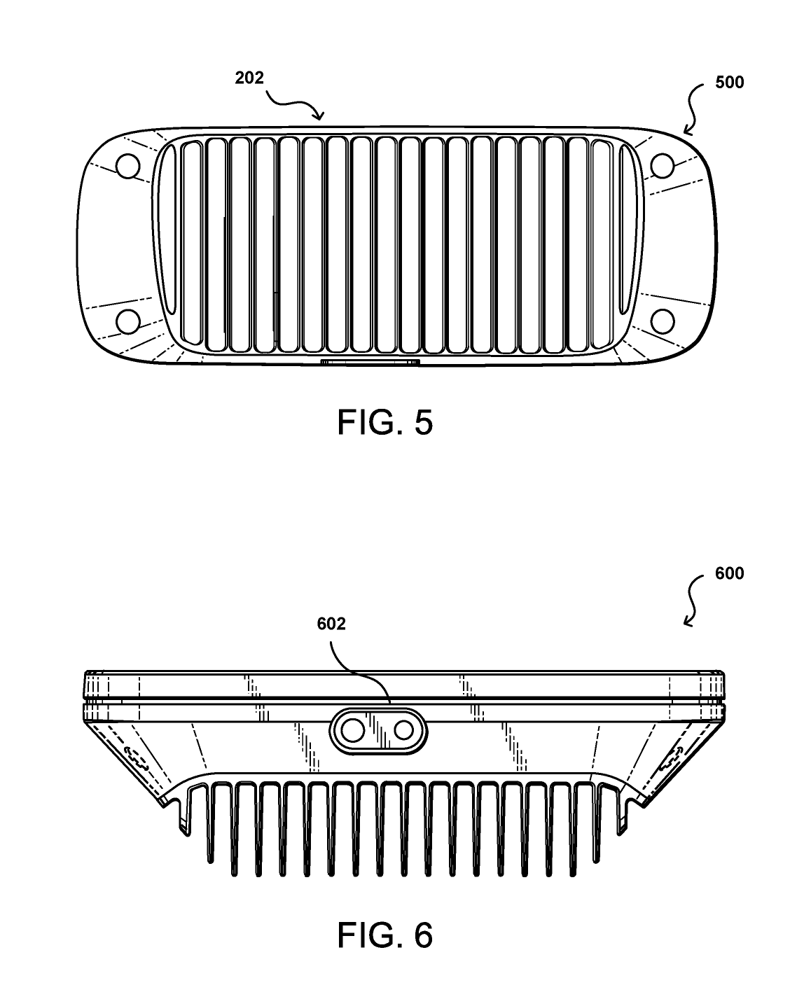

FIG. 4 illustrates a side view of an example device showing recesses 402 that can receive the dimples of the mounting bracket 204 of FIG. 2, as well as a threaded hole 404 for receiving a security screw or other such attachment mechanism. Also shown are openings 406 allowing for the device housing to be assembled and secured using screws or other such mechanisms, while other embodiments might utilize attachment approaches such as physical snaps, adhesive, or clamps, among other such options. FIG. 5 illustrates an example rear view 500 of the device illustrating an example heat sink configuration, as well as an arrangement of attachment openings as discussed previously. In this configuration the bracket would wrap around the heat sink fins 202, but in other embodiments the bracket might sit below or around the fins, among other such options. FIG. 6 illustrates a bottom view 600 of an example detection device. In this view a pair of attachment mechanisms 602 is illustrated. One of the attachment mechanisms can be configured to receive an attachment screw for the mounting bracket. The other mechanism can be configured to accept a standard photography attachment, such as may enable the device to be connected to a photography tripod or other such device. Such an attachment mechanism can enable the device to be temporarily positioned in various locations, such as may be appropriate for events or one-time object counts, etc.

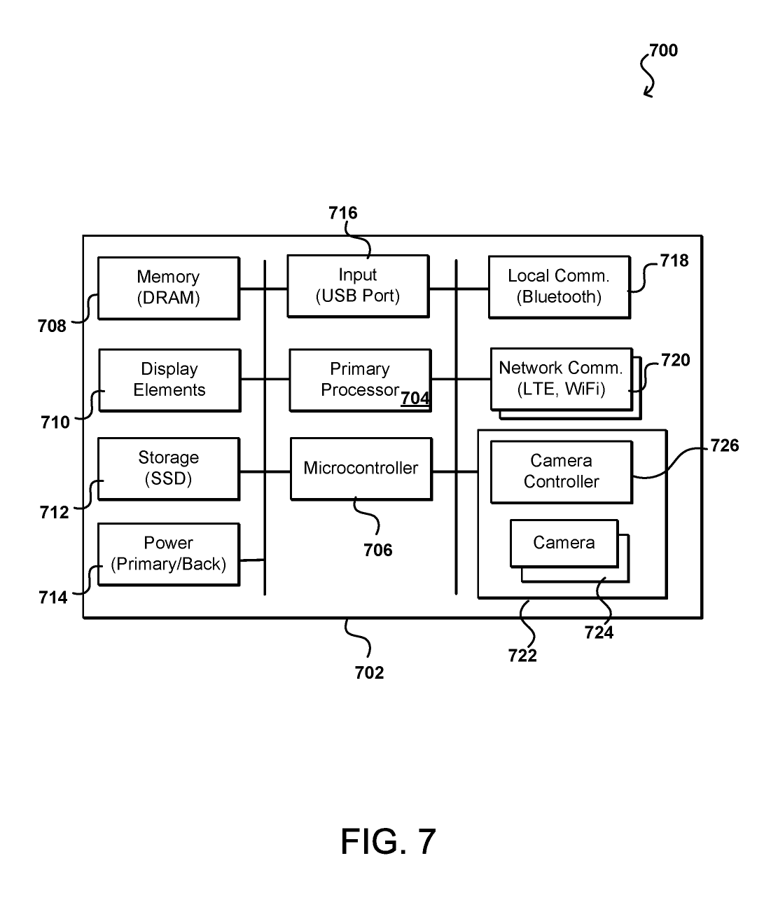

FIG. 7 illustrates an example set of components 700 that can be utilized in an example detection device in accordance with various embodiments. In this example, at least some of the components would be installed on one or more printed circuit boards (PCBs) 702 contained within the housing of the device. Elements such as the display elements 710 and cameras 724 can also be at least partially exposed through and/or mounted in the device housing. In this example, a primary processor 704 (e.g., at least one CPU) can be configured to execute instructions to perform various functionality discussed herein. The device can include both random access memory 708, such as DRAM, for temporary storage and persistent storage 712, such as may include at least one solid state drive SSD, although hard drives and other storage may be used as well within the scope of the various embodiments. In at least some embodiments, the memory 708 can have sufficient capacity to store frames of video content from both cameras 724 for analysis, after which time the data is discarded. The persistent storage 712 may have sufficient capacity to store a limited amount of video data, such as video for a particular event or occurrence detected by the device, but insufficient capacity to store lengthy periods of video data, which can prevent the hacking or inadvertent access to video data including representations of the people contained within the field of view of those cameras during the period of recording.

The detection device can include at least one display element 710. In various examples this includes one or more LEDs or other status lights that can provide basic communication to a technician or other observer of the device. It should be understood, however, that screens such as LCD screens or other types of displays can be used as well within the scope of the various embodiments. In at least some embodiments one or more speakers or other sound producing elements can also be included, which can enable alarms or other type of information to be conveyed by the device. Similarly, one or more audio capture elements such as a microphone can be included as well. This can allow for the capture of audio data in addition to video data, either to assist with analysis or to capture audio data for specific periods of time, among other such options. As mentioned, if a security alarm is triggered the device might capture video data (and potentially audio data if a microphone is included) for subsequent analysis and/or to provide updates on the location or state of the emergency, etc. In some embodiments a microphone may not be included for privacy or power concerns, among other such reasons.

The detection device 702 can include various other components, including those shown and not shown, that might be included in a computing device as would be appreciated to one of ordinary skill in the art. This can include, for example, at least one power component 714 for powering the device. This can include, for example, a primary power component and a backup power component in at least one embodiment. For example, a primary power component might include power electronics and a port to receive a power cord for an external power source, or a battery to provide internal power, among solar and wireless charging components and other such options. The device might also include at least one backup power source, such as a backup battery, that can provide at least limited power for at least a minimum period of time. The backup power may not be sufficient to operate the device for length periods of time, but may allow for continued operation in the event of power glitches or short power outages. The device might be configured to operate in a reduced power state, or operational state, while utilizing backup power, such as to only capture data without immediate analysis, or to capture and analyze data using only a single camera, among other such options. Another option is to turn off (or reduce) communications until full power is restored, then transmit the stored data in a batch to the target destination. As mentioned, in some embodiments the device may also have a port or connector for docking with the mounting bracket to receive power via the bracket.

The device can have one or more network communications components 720, or subsystems, that enable the device to communicate with a remote server or computing system. This can include, for example, a cellular modem for cellular communications (e.g., LTE, 5G, etc.) or a wireless modem for wireless network communications (e.g., WiFi for Internet-based communications). The device can also include one or more components 718 for “local” communications (e.g., Bluetooth) whereby the device can communicate with other devices within a given communication range of the device. Examples of such subsystems and components are well known in the art and will not be discussed in detail herein. The network communications components 720 can be used to transfer data to a remote system or service, where that data can include information such as count, object location, and tracking data, among other such options, as discussed herein. The network communications component can also be used to receive instructions or requests from the remote system or service, such as to capture specific video data, perform a specific type of analysis, or enter a low power mode of operation, etc. A local communications component 718 can enable the device to communicate with other nearby detection devices or a computing device of a repair technician, for example. In some embodiments, the device may additionally (or alternatively) include at least one input 716 and/or output, such as a port to receive a USB, micro-USB, FireWire, HDMI, or other such hardwired connection. The inputs can also include devices such as keyboards, push buttons, touch screens, switches, and the like.

The illustrated detection device also includes a camera subsystem 722 that includes a pair of matched cameras 724 for stereoscopic video capture and a camera controller 726 for controlling the cameras. Various other subsystems or separate components can be used as well for video capture as discussed herein and known or used for video capture. The cameras can include any appropriate camera, as may include a complementary metal-oxide-semiconductor (CMOS), charge coupled device (CCD), or other such sensor or detector capable of capturing light energy over a determined spectrum, as may include portions of the visible, infrared, and/or ultraviolet spectrum. Each camera may be part of an assembly that includes appropriate optics, lenses, focusing elements, shutters, and other such elements for image capture by a single camera, set of cameras, stereoscopic camera assembly including two matched cameras, or other such configuration. Each camera can also be configured to perform tasks such as autofocusing, zoom (optical or digital), brightness and color adjustments, and the like. The cameras 724 can be matched digital cameras of an appropriate resolution, such as may be able to capture HD or 4K video, with other appropriate properties, such as may be appropriate for object recognition. Thus, high color range may not be required for certain applications, with grayscale or limited colors being sufficient for some basic object recognition approaches. Further, different frame rates may be appropriate for different applications. For example, thirty frames per second may be more than sufficient for tracking person movement in a library, but sixty frames per second may be needed to get accurate information for a highway or other high speed location. As mentioned, the cameras can be matched and calibrated to obtain stereoscopic video data, or at least matched video data that can be used to determine disparity information for depth, scale, and distance determinations. The camera controller 726 can help to synchronize the capture to minimize the impact of motion on the disparity data, as different capture times would cause some of the objects to be represented at different locations, leading to inaccurate disparity calculations.

The example detection device 700 also includes a microcontroller 706 to perform specific tasks with respect to the device. In some embodiments, the microcontroller can function as a temperature monitor or regulator that can communicate with various temperature sensors (not shown) on the board to determine fluctuations in temperature and send instructions to the processor 704 or other components to adjust operation in response to significant temperature fluctuation, such as to reduce operational state if the temperature exceeds a specific temperature threshold or resume normal operation once the temperature falls below the same (or a different) temperature threshold. Similarly, the microcontroller can be responsible for tasks such as power regulation, data sequencing, and the like. The microcontroller can be programmed to perform any of these and other tasks that relate to operation of the detection device, separate from the capture and analysis of video data and other tasks performed by the primary processor 704.

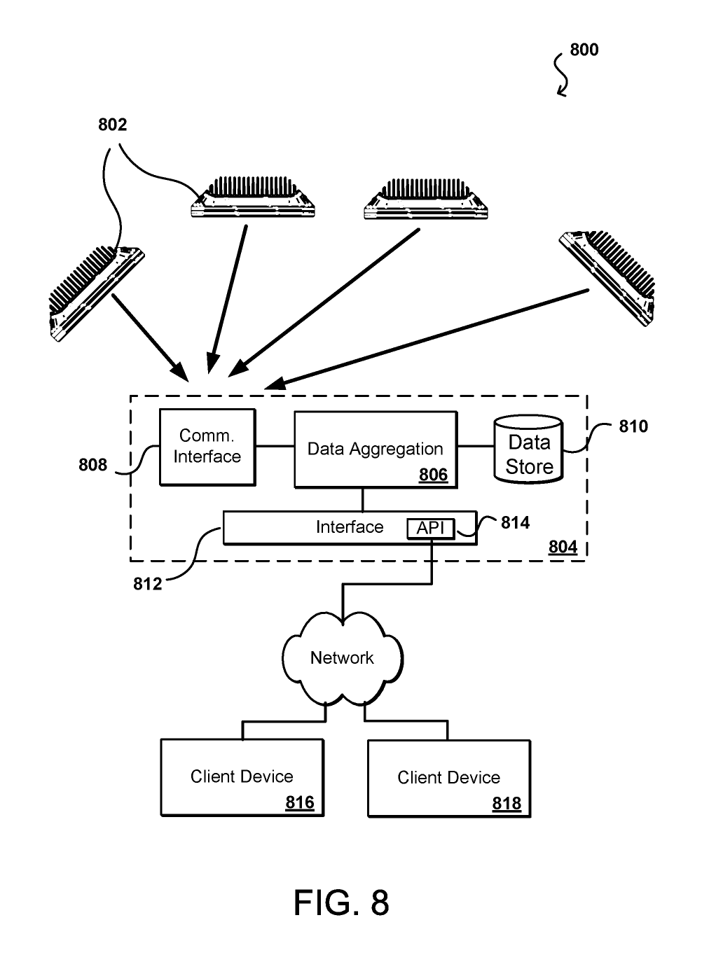

FIG. 8 illustrates an example system implementation 800 that can utilize a set of detection devices in accordance with various embodiments. In this example, a set of detection devices 802 is positioned about a specific location to be monitored. This can include mounting the devices with a location and orientation such that areas of interest at the location are within the field of view of cameras of at least one of the detection devices. If tracking of objects throughout the areas is to be performed, then the detection devices can be positioned with substantially or minimally overlapping fields of view as discussed elsewhere herein. Each detection device can capture video data and analyze that data on the respective device. After analysis, each video frame can be discarded such that no personal or private data is subsequently stored on the device. Information such as the number of objects, types of objects, locations of objects, and movement of objects can be transmitted across at least one communication mechanism, such as a cellular or wireless network based connection, to be received to an appropriate communication interface 808 of a data service provider environment 804. In this example, the data service provider environment includes various resources (e.g., servers, databases, routers, load balancers, and the like) that can receive and process the object data from the various detection devices. As mentioned, this can include a network interface that is able to receive the data through an appropriate network connection. It should be understood that even if the data from the detection devices 802 is sent over a cellular connection, that data might be received by a cellular service provider and transmitted to the data service provider environment 804 using another communication mechanism, such as an Internet connection, among other such options.

The data from the devices can be received to the communication interface and then directed to a data aggregation server 806, or other such system or service, which can correlate the data received from the various detection devices 802 for a specific region or location. This can include not aggregating the data from the set of devices for a location, but potentially performing other tasks such as time sequencing, device location and overlap determinations, and the like. In some embodiments, such an approach can provide the ability to track a single object through overlapping fields of view of different devices as discussed elsewhere herein. Such a process can be referred to as virtual stitching, wherein the actual image or video data is not stitched together but the object paths or locations are “stitched” or correlated across a large area monitored by the devices. The data aggregation server 806 can also process the data itself, or in combination with another resource of (or external to) the environment 804, to determine appropriate object determination, correlation, count, movement, and the like. For example, if two detection devices have overlapping fields of view, then some objects might be represented in data captured by each of those two devices. The aggregation server 806 can determine that, based on the devices providing the data, the relative orientation and field overlap of the devices, and positions where the object is represented in both sets of data, that the object is the same object represented in both data sets. As mentioned elsewhere herein, one or more descriptor values may also be provided that can help correlate object between frames and/or different fields of view. The aggregation server can then correlate these representations such that the object is only counted once for that location. The aggregation server can also, in at least some embodiments, correlate the data with data from a previous frame in order to correlate objects over time as well. This can help to not only ensure that a single object is only counted once even though represented in multiple video frames over time, but can also help to track motion of the objects through the location where object tracking is of interest. In some embodiments, descriptors or other contextual data for an object (such as the determined hair color, age, gender, height, or shirt color) can be provided as well to help correlate the objects, since only time and coordinate data is otherwise provided in at least some embodiments. Other basic information may be provided as well, such as may include object type (e.g., person or car) or detection duration information. Information from the analysis can then be stored to at least one data store 810. The data stored can include the raw data from the devices, the aggregated or correlated data from the data aggregation server, report data generated by a reporting server or application, or other such data. The data stored in some embodiments can depend at least in part upon the preferences or type of account of a customer of the data service provider who pays or subscribes to receive information based on the data provided by the detection devices 802 at the particular location. In some embodiments, basic information such as the raw data is always stored, with count, tracking, report, or other data being configurable or selectable by one or more customers or other such entities associated with account.

In order to obtain the data, a request can be submitted from various client devices 816, 818 to an interface layer 812 of the data service provider environment. The interface can include any appropriate interface, such as may correspond to a network address or application programming interface (API). The communication interface 808 for communicating with the detection devices 808 can be part of, or separate from, this interface layer. In some embodiments the client devices 816, 818 may be able to submit requests that enable the detection device data to be sent directly to the client devices 816, 818 for analysis. The client devices can then use a corresponding user interface, application, command prompt, or other such mechanism to obtain the data. This can include, for example, obtaining the aggregated and correlated data from the data store or obtaining reports generated based on that data, among other such options. Customized reports or interfaces can be provided that enable customers or authorized users to obtain the information of interest. The client devices can include any appropriate devices operable to send and receive requests, messages, or information over an appropriate network and convey information back to a user of the device. Examples of such client devices include personal computers, smart phones, handheld messaging devices, wearable computers, desktop computers, notebook computers, tablets, and the like. Such an approach enables a user to obtain the data of interest, as well as to request further information or new types of information to be collected or determined. It should be understood that although many components are shown as part of a data service provider environment 804 that the components can be part of various different environments, associated with any of a number of different entities, or associated with no specific environment, among other such options.

In at least some embodiments at least one valid credential will need to be provided in order to access the data from the data service provider environment 804. This can include, for example, providing a username and password to be authenticated by the data service environment (or an identity management service in communication with the environment, for example) that is valid and authorized to obtain or access the data, or at least a portion of the data, under the terms of the corresponding customer account. In some embodiments a customer will have an account with the data service provider, and user can obtain credentials under permission from the customer account. In some embodiments the data may be encrypted before storage and/or transmission, where the encryption may be performed using a customer encryption key or asymmetric key pair, among other such options. The data may also be transferred using a secure transmission protocol, among other such options.

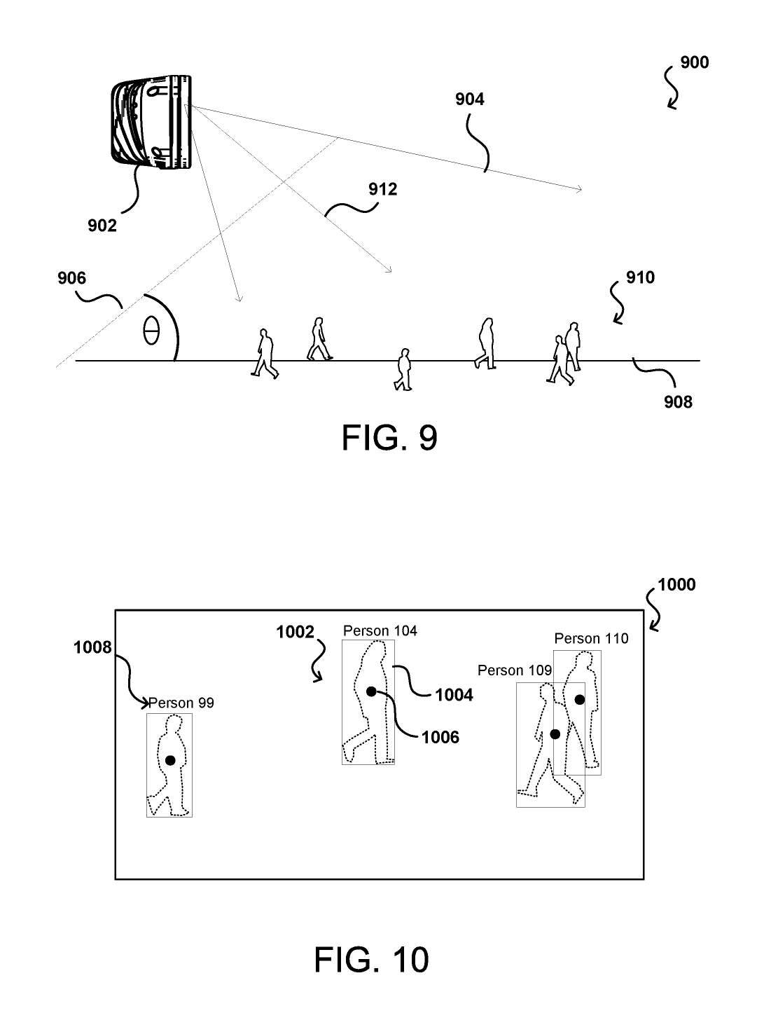

FIG. 9 illustrates an example arrangement 900 in which a detection device can capture and analyze video information in accordance with various embodiments. In this example, the detection device 902 is positioned with the front face substantially vertical, and the detection device at an elevated location, such that the field of view 904 of the cameras of the device is directed towards a region of interest 908, where that region is substantially horizontal (although angled or non-planar regions can be analyzed as well in various embodiments). As mentioned, the cameras can be angled such that a primary axis 912 of each camera is pointed towards a central portion of the region of interest. In this example, the cameras can capture video data of the people 910 walking in the area of interest. As mentioned, the disparity information obtained from analyzing the corresponding video frames from each camera can help to determine the distance to each person, as well as information such as the approximate height of each person. If the detection device is properly calibrated the distance and dimension data should be relatively accurate based on the disparity data. The video data can be analyzed using any appropriate object recognition process, computer vision algorithm, artificial neural network (ANN), or other such mechanism for analyzing image data (i.e., for a frame of video data) to detect objects in the image data. The detection can include, for example, determining feature points or vectors in the image data that can then be compared against patterns or criteria for specific types of objects, in order to identify or recognize objects of specific types. Such an approach can enable objects such as benches or tables to be distinguished from people or animals, such that only information for the types of object of interest can be processed.

In this example, the cameras capture video data which can then be processed by at least one processor on the detection device. The object recognition process can detect objects in the video data and then determine which of the objects correspond to objects of interest, in this example corresponding to people. The process can then determine a location of each person, such as by determining a boundary, centroid location, or other such location identifier. The process can then provide this data as output, where the output can include information such as an object identifier, which can be assigned to each unique object in the video data, a timestamp for the video frame(s), and coordinate data indicating a location of the object at that timestamp. In one embodiment, a location (x, y, z) timestamp (t) can be generated as well as a set of descriptors (d1, d2, . . . ) specific to the object or person being detected and/or tracked. Object matching across different frames within a field of view, or across multiple fields of view, can then be performed using a multidimensional vector (e.g., x, y, z, t, d1, d2, d3, . . . ). The coordinate data can be relative to a coordinate of the detection device or relative to a coordinate set or frame of reference previously determined for the detection device. Such an approach enables the number and location of people in the region of interest to be counted and tracked over time without transmitting, from the detection device, any personal information that could be used to identify the individual people represented in the video data. Such an approach maintains privacy and prevents violation of various privacy or data collection laws, while also significantly reducing the amount of data that needs to be transmitted from the detection device.

As illustrated, however, the video data and distance information will be with respect to the cameras, and a plane of reference 906 of the cameras, which can be substantially parallel to the primary plane(s) of the camera sensors. For purposes of the coordinate data provided to a customer, however, the customer will often be more interested in coordinate data relative to a plane 908 of the region of interest, such as may correspond to the floor of a store or surface of a road or sidewalk that can be directly correlated to the physical location. Thus, in at least some embodiments a conversion or translation of coordinate data is performed such that the coordinates or position data reported to the customer corresponds to the plane 908 (or non-planar surface) of the physical region of interest. This translation can be performed on the detection device itself, or the translation can be performed by a data aggregation server or other such system or service discussed herein that receives the data, and can use information known about the detection device 902, such as position, orientation, and characteristics, to perform the translation when analyzing the data and/or aggregating/correlating the data with data from other nearby and associated detection devices. Mathematical approaches for translating coordinates between two known planes of reference are well known in the art and, as such, will not be discussed in detail herein.

FIG. 10 illustrates an example type of data 1000 that can be obtained from a detection device in accordance with various embodiments. In this example, the dotted lines represent people 1002 who are contained within the field of view of the cameras of a detection device, and thus represented in the captured video data. After recognition and analysis, the people can be represented in the output data by bounding box 1004 coordinates or centroid coordinates 1006, among other such options. As mentioned, each person (or other type of object of interest) can also be assigned a unique identifier 1008 that can be used to distinguish that object, as well as to track the position or movement of that specific object over time. Where information about objects is stored on the detection device for at least a minimum period of time, such an identifier can also be used to identify a person that has walked out of, and back into, the field of view of the camera. Thus, instead of the person being counted twice, this can result in the same identifier being applied and the count not being updated for the second encounter. There may be a maximum amount of time that the identifying data is stored on the device, or used for recognition, such that if the user comes back for a second visit at a later time this can be counted as a separate visit for purposes of person count in at least some embodiments. In some embodiments the recognition information cached on the detection device for a period of time can include a feature vector made up of feature points for the person, such that the person can be identified if appearing again in data captured by that camera while the feature vector is still stored. It should be understood that while primary uses of various detection devices do not transmit feature vectors or other identifying information, such information could be transmitted if desired and permitted in at least certain embodiments.

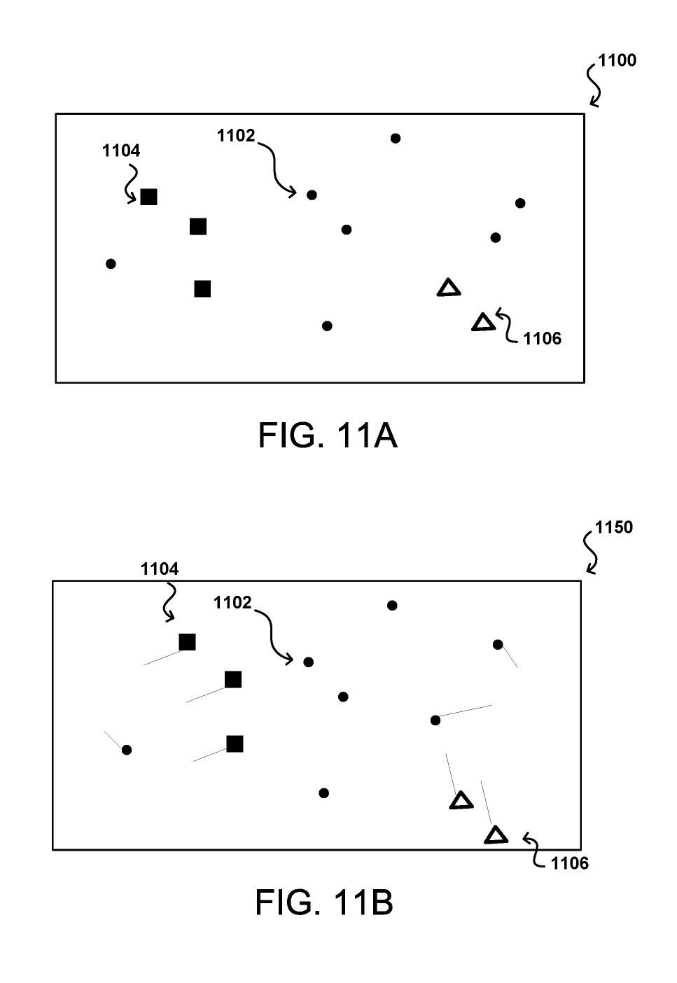

The locations of the specific objects can be tracked over time, such as by monitoring changes in the coordinate information determined for a sequence of video frames over time. As an example, FIGS. 11A and 11B illustrate object data for two different frames in a sequence of frames (not necessarily adjacent frames in the sequence) of captured and analyzed video data. In the example object data 100 illustrated in FIG. 11A, there are three types 1102, 1104, 1106 of objects of interest that have been recognized. The type of object and position for each object can be reported by the detection device and/or data service, such that a customer can determine where objects of different types are located in the region of interest. FIG. 11B illustrates object data 1150 for a subsequent point in time, as represented by another frame of stereoscopic video data (or other captured image data). This example set shows the updated location of the objects at a subsequent point in time. The changes or differences in position data (represented by the line segments in the image) show the movement of those objects over that period of time. This information can be utilized to determine a number of different types of information. In addition to the number of objects of each type, this can be used to show where those types of objects are generally located and how they move throughout the area. If, for example, the types of objects represent people, automobiles, and bicycles, then such information can be used to determine how those objects move around an intersection, and can also be used to detect when a bicycle or person in in the street disrupting traffic, a car is driving on a sidewalk, or another occurrence is detected such that an action can be taken. As mentioned, an advantage of approaches discussed herein is that the position (and other) information can be provided in near real time, such that the determination of the occurrence can be determined while the occurrence is ongoing, such that an action can be taken. This can include, for example, generating audio instructions, activating a traffic signal, dispatching a security officer, or another such action. The real time analysis can be particularly useful for security purposes, where action can be taken as soon as a particular occurrence is detected, such as a person detected in an unauthorized area, etc. Such real time aspects can be beneficial for other purposes as well, such as being able to move employees to customer service counters or cash registers as needed based on current customer locations, line lengths, and the like. For traffic monitoring, this can help determine when to activate or deactivate metering lights, change traffic signals, and perform other such actions.

In other embodiments the occurrence may be logged for subsequent analysis, such as to determine where such occurrences are taking place in order to make changes to reduce the frequency of such occurrences. If in a store situation, such movement data can alternatively be used to determine how men and women move through a store, such that the store can optimize the location of various products or attempt to place items to direct the persons to different regions in the store. The data can also help to alert when a person is in a restricted area or otherwise doing something that should generate an alarm, alert, notification, or other such action.

In various embodiments, some amount of image pre-processing can be performed for purposes of improving the quality of the image, as may include filtering out noise, adjusting brightness or contrast, etc. In cases where the camera might be moving or capable of vibrating or swaying on a pole, for example, some amount of position or motion compensation may be performed as well. Background subtraction approaches that can be utilized with various embodiments include mean filtering, frame differencing, Gaussian average processing, background mixture modeling, mixture of Gaussians (MoG) subtraction, and the like. Libraries such as the OPEN CV library can also be utilized to take advantage of the conventional background and foreground segmentation algorithm.

Once the foreground portions or “blobs” of image data are determined, those portions can be processed using a computer vision algorithm for object recognition or other such process. Object recognition typically makes use of one or more classifiers that have been trained to recognize specific types of categories of objects, such as people, cars, bicycles, and the like. Algorithms used for such purposes can include convolutional or other deep neural networks (DNNs), as may utilize one or more feature extraction libraries for identifying types of feature points of various objects. In some embodiments, a histogram or oriented gradients (HOG)-based approach uses feature descriptors for object detection, such as by counting occurrences of gradient orientation in localized portions of the image data. Other approaches that can be used take advantage of features such as edge orientation histograms and shape contexts, as well as scale- and rotation-invariant feature transform descriptors, although these approaches may not provide the same level of accuracy for at least some data sets.

In some embodiments, an attempt to classify objects that does not require precision can rely on the general shapes of the blobs or foreground regions. For example, there may be two blobs detected that correspond to different types of objects. The first blob can have an outline or other aspect determined that a classifier might indicate corresponds to a human with 85% certainty. Certain classifiers might provide multiple confidence or certainty values, such that the scores provided might indicate an 85% likelihood that the blob corresponds to a human and a 5% likelihood that the blob corresponds to an automobile, based upon the correspondence of the shape to the range of possible shapes for each type of object, which in some embodiments can include different poses or angles, among other such options. Similarly, a second blob might have a shape that a trained classifier could indicate has a high likelihood of corresponding to a vehicle. For situations where the objects are visible over time, such that additional views and/or image data can be obtained, the image data for various portions of each blob can be aggregated, averaged, or otherwise processed in order to attempt to improve precision and confidence. As mentioned elsewhere herein, the ability to obtain views from two or more different cameras can help to improve the confidence of the object recognition processes.

Where more precise identifications are desired, the computer vision process used can attempt to locate specific feature points as discussed above. As mentioned, different classifiers can be used that are trained on different data sets and/or utilize different libraries, where specific classifiers can be utilized to attempt to identify or recognize specific types of objects. For example, a human classifier might be used with a feature extraction algorithm to identify specific feature points of a foreground object, and then analyze the spatial relations of those feature points to determine with at least a minimum level of confidence that the foreground object corresponds to a human. The feature points located can correspond to any features that are identified during training to be representative of a human, such as facial features and other features representative of a human in various poses. Similar classifiers can be used to determine the feature points of other foreground object in order to identify those objects as vehicles, bicycles, or other objects of interest. If an object is not identified with at least a minimum level of confidence, that object can be removed from consideration, or another device can attempt to obtain additional data in order to attempt to determine the type of object with higher confidence. In some embodiments the image data can be saved for subsequent analysis by a computer system or service with sufficient processing, memory, and other resource capacity to perform a more robust analysis.

After processing using a computer vision algorithm with the appropriate classifiers, libraries, or descriptors, for example, a result can be obtained that is an identification of each potential object of interest with associated confidence value(s). One or more confidence thresholds or criteria can be used to determine which objects to select as the indicated type. The setting of the threshold value can be a balance between the desire for precision of identification and the ability to include objects that appear to be, but may not be, objects of a given type. For example, there might be 1,000 people in a scene. Setting a confidence threshold too high, such as at 99%, might result in a count of around 100 people, but there will be a very high confidence that each object identified as a person is actually a person. Setting a threshold too low, such as at 50%, might result in too many false positives being counted, which might result in a count of 1,500 people, one-third of which do not actually correspond to people. For applications where approximate counts are desired, the data can be analyzed to determine the appropriate threshold where, on average, the number of false positives is balanced by the number of persons missed, such that the overall count is approximately correct on average. For many applications this can be a threshold between about 60% and about 85%, although as discussed the ranges can vary by application or situation.

The ability to recognize certain types of objects of interest, such as pedestrians, bicycles, and vehicles, enables various types of data to be determined that can be useful for a variety of purposes. As mentioned, the ability to count the number of cars stopped at an intersection or people in a crosswalk can help to determine the traffic in a particular area, and changes in that count can be monitored over time to attempt to determine density or volume as a factor of time. Tracking these objects over time can help to determine aspects such as traffic flow and points of congestion. Determining irregularities in density, behavior, or patterns can help to identify situations such as accidents or other unexpected incidents.

The ability to obtain the image data and provide data regarding recognized objects could be offered as a standalone system that can be operated by agencies or entities such as traffic departments and other governmental agencies. The data also can be provided as part of a service, whereby an organization collects and analyzes the image data, and provides the data as part of a one-time project, ongoing monitoring project, or other such package. The customer of the service can specify the type of data desired, as well as the frequency of the data or length of monitoring, and can be charged accordingly. In some embodiments the data might be published as part of a subscription service, whereby a mobile app provider or other such entity can obtain a subscription in order to publish or obtain the data for purposes such as navigation and route determination. Such data also can be used to help identify accidents, construction, congestion, and other such occurrences.

As mentioned, many of the examples herein utilize image data captured by one or more detection devices with a view of an area of interest. In addition to one or more digital still image or video cameras, these devices can include infrared detectors, stereoscopic cameras, thermal sensors, motion sensors, proximity sensors, and other such sensors or components. The image data captured can include one or more images, or video, indicating pixel values for pixel locations of the camera sensor, for example, where the pixel values can represent data such as the intensity or color of ambient, infrared IR, or ultraviolet (UV) radiation detected by the sensor. A device may also include non-visual based sensors, such as radio or audio receivers, for detecting energy emanating from various objects of interest. These energy sources can include, for example, cell phone signals, voices, vehicle noises, and the like. This can include looking for distinct signals or a total number of signals, as well as the bandwidth, congestion, or throughput of signals, among other such options. Audio and other signature data can help to determine aspects such as type of vehicle, regions of activity, and the like, as well as providing another input for counting or tracking purposes. The overall audio level and direction of the audio can also provide an additional input for potential locations of interest.

In some embodiments, a detection device can include an active, structured-light sensor. Such an approach can utilize a set of light sources, such as a laser array, that projects a pattern of light of a certain wavelength, such as in the infrared (IR) spectrum, that may not be detectable by the human eye. One or more structured light sensors can be used, in place of or in addition to the ambient light camera sensors, to detect the reflected IR light. In some embodiments sensors can be used that detect light over the visible and infrared spectrums. The size and placement of the reflected pattern components can enable the creation of a three-dimensional mapping of the objects within the field of view. Such an approach may require more power, due to the projection of the IR pattern, but may provide more accurate results in certain situations, such as low light situations or locations where image data is not permitted to be captured, etc.

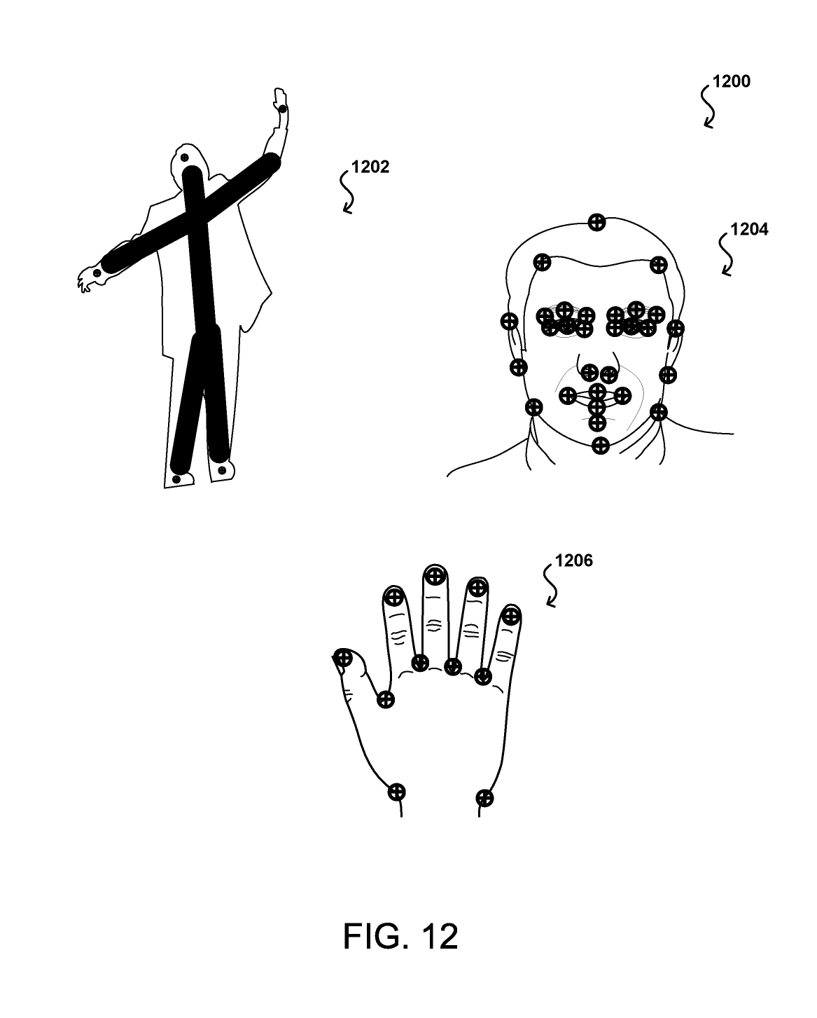

It should be understood that information about the objects themselves can also be determined using approaches discussed and suggested herein. For example, FIG. 12 illustrates various aspects of different objects that can be detected and reported within the scope of the various embodiments. For example, the feature points detected for a person can be used to determine a pose 1202 or orientation of that person. In addition to determining that an object corresponds to a person, this can be used to identify persons attempting to flag a cab, running, carrying items, or performing other such tasks. Similarly, the feature points for a person's face 1204 can be used to identify the person, estimate their age or gender, determine their expression, and perform other such tasks. This can be helpful to identify the number of people who appear upset or angry, which can be useful in determining a current level of customer service or type of customer experience. Such an approach can also be helpful for detecting security risks. Portions of a person's body can also be analyzed, such as to determine the placement of a user's fingers 1206 to detect specific motions or gestures, as well as other aspects that may be of interest to a customer in various embodiments. Approaches for determining feature points and aspects such as pose, expression, and orientation based on those feature points are known in the art and as such will not be discussed in detail herein.

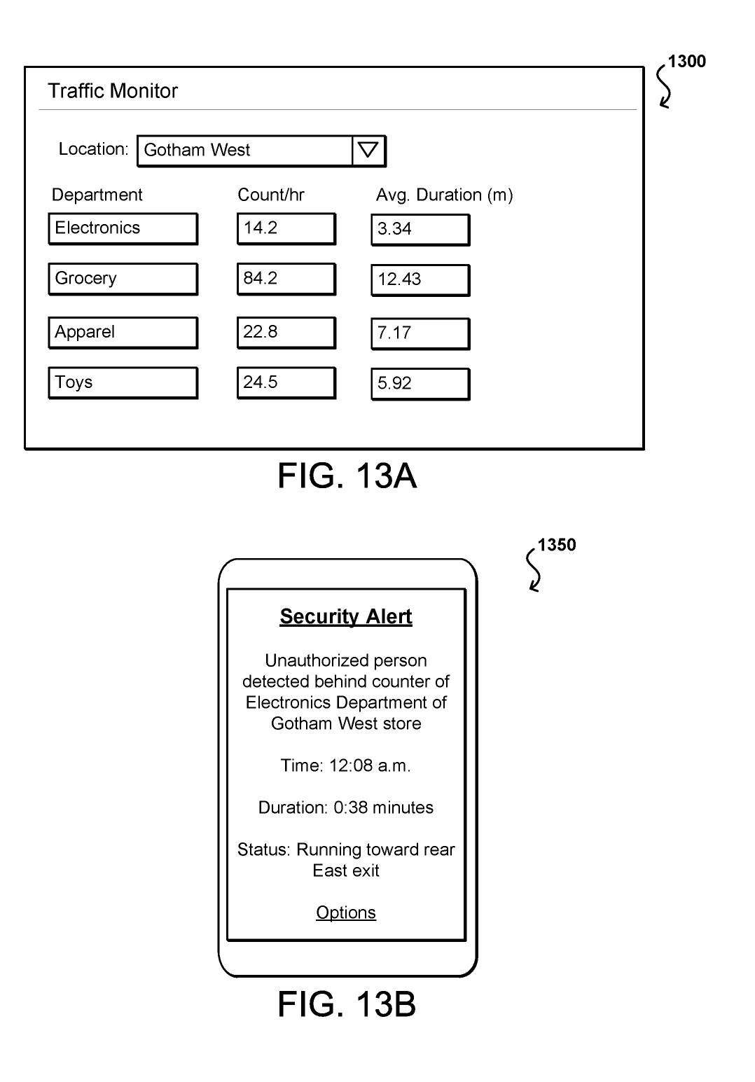

FIGS. 13A and 13B illustrate example interfaces that can be utilized in accordance with various embodiments. The example interface 1300 of FIG. 13A illustrates functionality that may be available to customers or consumers of a data monitoring service or other such provider. In this example, the customer can select an option to specify a location that is being monitored by one or more detection devices. In this example, the location is a store of a chain of stores. The customer can then specify specific locations for which to receive information, such as may relate to different departments in the store. In response, the user can obtain information such as the number of people on average in that department over a period of time, the number of people currently in that department, and other such information. The display can also provide information about the average amount of time a person spends in each department. Other information can be provided as well, such as paths of movement through the store or a given department, an ordering of departments on a visit, how many departments the average person visits, and the like. If such information is collected an available, the data can also include counts or percentages broken down by age, gender, interest, style, and the like. The types of information can be fixed or capable of being specified or modified by the customer. In some embodiments, different customers will be able to access different types of information, and there may be different roles or permissions specified as far as what may be done with that data, among other such options.

FIG. 13B illustrates an example display 1350 or notification that might be generated in response to detecting a specific object or occurrence, among other such options. In this example, a person was detected in a specific location at a time when people should not be at that location. Here, an unauthorized person was detected behind a counter when the store was closed. As mentioned, things like name tags or uniforms can be used to identify a type of person, such as an employee or authorized person. Here, the simple detection of a person at that location and time was enough to satisfy an alert criteria which can cause a notification (e.g., SMS, instant message, or text message) to be generated for an appropriate security guard or other such person. Various other types of notifications, alerts, or messages can be generated as well in response to various criteria or detections discussed and suggested herein.

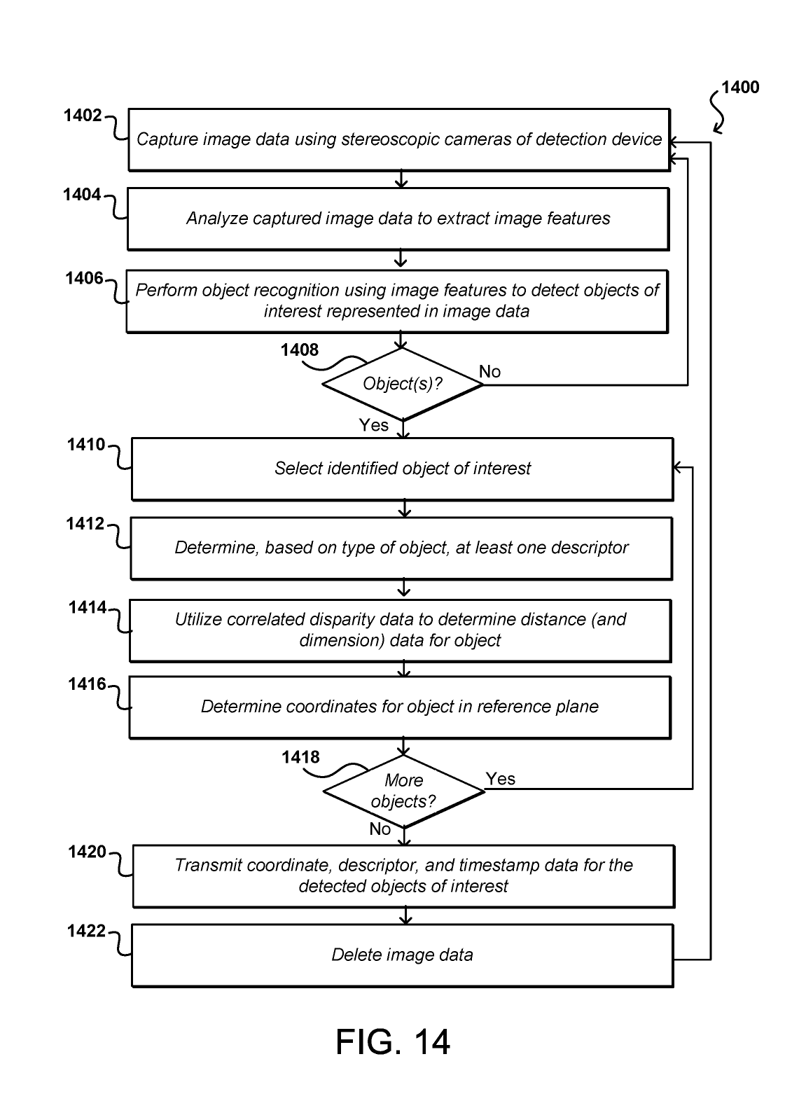

FIG. 14 illustrates an example process 1400 for detecting objects using a detection device, such as those discussed herein, that can be utilized in accordance with various embodiments. It should be understood for this and other processes discussed herein that there can be additional, alternative, or fewer steps performed in similar or alternative orders, or in parallel, within the scope of the various embodiments unless otherwise stated. In this example, image data is captured 1402 using a stereoscopic camera (or other pair of matched cameras) of a detection device. As discussed, other numbers or types of cameras or sensors can be used as well within the scope of the various embodiments. The image data in this example can correspond to a single digital image or a frame of digital video, among other such options. The captured image data can be analyzed 1404, on the detection device, to extract image features or other points or aspects that may be representative of objects in the image data. These can include any appropriate image features discussed or suggested herein. Object recognition, or another object detection process, can be performed 1406 on the detection device using the extracted image features. The object recognition process can attempt to determine a presence of objects represented in the image data, such as those that match object patterns or have feature vectors that correspond to various defined object types, among other such options. In at least some embodiments each potential object determination will come with a corresponding confidence value, for example, and objects with at least a minimum confidence value that corresponding to specified types of objects may be selected as objects of interest. If it is determined 1408 that no objects of interest are represented in the frame of image data then the image data can be discarded and new image data captured.

If, however, one or more objects of interest are detected in the image data, the objects can be analyzed to determine relevant information. In the example process the objects will be analyzed individually for purposes of explanation, but it should be understood that object data can be analyzed concurrently as well in at least some embodiments. An object of interest can be selected 1410 and at least one descriptor for that object can be determined 1412. The types of descriptor in some embodiments can depend at least in part upon the type of object. For example, a human object might have descriptors relating to height, clothing color, gender, or other aspects discussed elsewhere herein. A vehicle, however, might have descriptors such as vehicle type and color, etc. The descriptors can vary in detail, but should be sufficiently specific such that two objects in similar locations in the area can be differentiated based at least in part upon those descriptors. The disparity data for the object, from the image feature data correlated from each of the stereo cameras in this example, can be utilized to determine 1412 distance information for the object. As mentioned, a centroid or other point may be determined as a tracking point for the object, and the disparity information used to determine a distance from the detection device to that representative point. In some embodiments the disparity data can be used to determine dimensional data as well, such as height or length data, which can be returned as some of the descriptor data in at least some embodiments. The disparity data can also be used along with the location of the object in the image data to determine 1416 coordinates for the object in a reference plane for the monitored area. As mentioned, the image plane of the cameras will be different than the plane of interest for the area, as may correspond to the ground or a floor plane, such that some coordinate transform may need to be performed to determine the coordinates for the object with respect to the plane of reference. As mentioned, the area of interest can have been mapped during a calibration or setup process such that the distance and point location information can be used to determine the coordinates in the relevant coordinate system. The process can be repeated for the next object if it is determined 1418 that there are more objects of interest in the image data. Otherwise, the coordinate, descriptor, and timestamp data for the objects can be transmitted 1420 from the detection device to the specified location, such as an address associated with a remote monitoring service. The information in at least some embodiments will be transmitted in one batch per analyzed image frame, although other groupings can be used as well within the scope of the various embodiments. The image data for the frame can also be deleted 1422 once analyzed, either immediately or after some period of time, such that no personal or identifying data can be extracted from the device by an unauthorized entity.

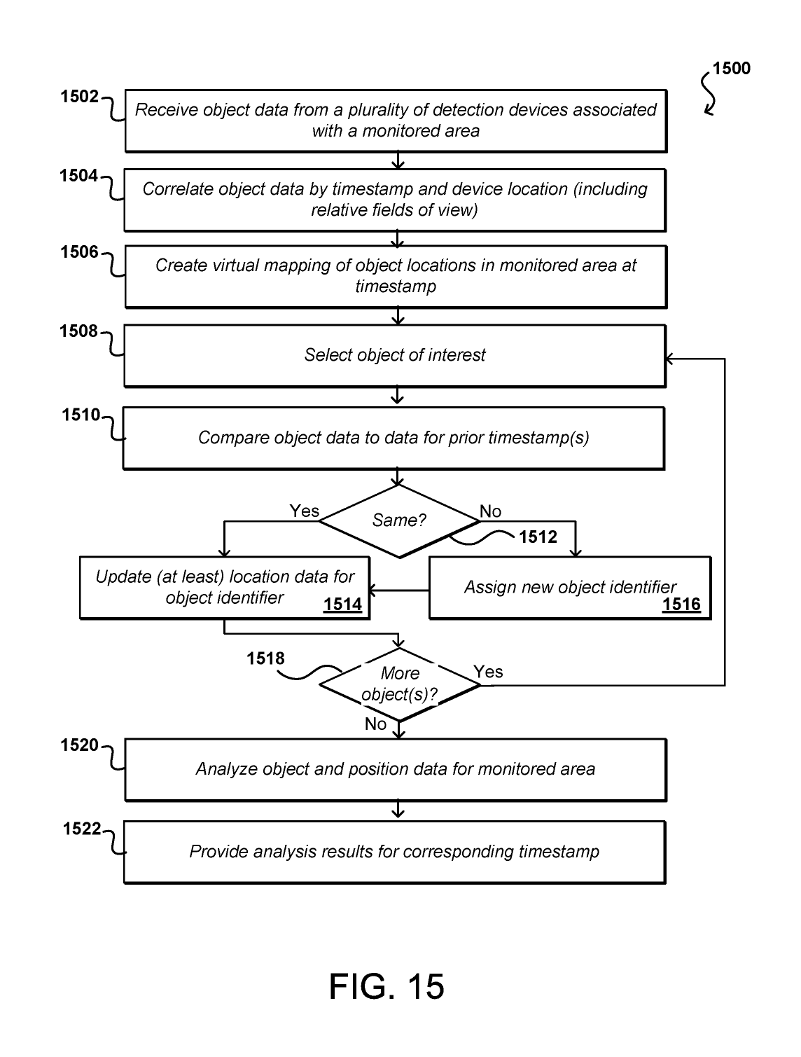

FIG. 15 illustrates an example process 1500 for aggregating and analyzing object data from multiple detection devices for an area of interest that can be utilized in accordance with various embodiments. In this example, object data is received 1502 from a plurality of detection devices associated with a monitored area of interest. The data can include data such as coordinate, descriptor, and time data for each object detected by a corresponding detection device, such as is described with respect to the process 1400 of FIG. 14. The detection devices can be in known and/or fixed positions in, or with respect to, the area with at least some overlap in the fields of view of the respective cameras, such that objects can be tracked as they move between those fields of view within the area. The data from the various devices can be correlated 1504 by timestamp, or other timing data, such that the position data for the objects is consistent for a specific point (or short period) in time. Failing to coordinate based on time can cause data to be correlated that corresponds to different times, and can thus be exposed to motion effects that can impact the result data. The objects can also be correlated by the device location, including the relative fields of view, such that if an object is represented in the data captured by two different devices then the object will only be counted or identified once for the area of interest at the relevant time. In at least some embodiments, a virtual mapping can be created 1506 that indicates the determined locations of the objects of interest within the monitored area. In addition to the location and object identifiers, for example, the mapping may also include or represent additional information as well, as may relate to the type of object, etc.

For each object detected in the captured data, the object can be selected 1508 for further analysis. As with the prior described process of FIG. 14, the object processing will be described individually for simplicity of explanation but the analysis of various objects can occur concurrently or in parallel in at least some embodiments. The data for a particular object can be compared 1510 to data for at least one prior timestamp, such as the immediately preceding timestamp. A determination can be made 1512 as to whether the object is the same object as one represented in the data for an earlier timestamp. This can be based upon, for example, a similar location in the region, where the allowable distance change may be based at least in part upon the type of object, as a vehicle may be allowed a greater rate of movement than a human. Further, any descriptors for the object can be used to determine whether the object is likely the same as in data for a prior frame. Confidence levels can be computed, whereby some inaccuracy in the descriptors or position might be allowed while still being able to track the object. Some comparison against earlier frames might be performed as well, such as where the object is near an edge of the area and may have re-entered the area, or where a confidence level for the frame was low but the object is in a central portion of the area, where a data glitch may have occurred or the object may have performed an action or been in a configuration that made the descriptors difficult to determine. Various other factors may come into play as well that may make it beneficial to look at data over a previous period of time. If the object is determined to likely not have been represented in recently analyzed data then a new object identifier can be assigned 1516 to the object for tracking, and location data (as well as any new descriptor data) can be updated for the object corresponding to the identifier. If the object matches an earlier detected object, then the previously assigned identifier can be utilized and the corresponding information updated accordingly. The process can continue until all objects have been analyzed or another end criterion is met. Once the object data is determined, the data can be analyzed 1520 for the monitored area to determine information such as the types of objects present, a number of each type present, patterns of movements for those types of objects, and so on. The results of the analysis can then be provided 1522 for that corresponding timestamp, such as may be provided to a display, monitoring system, security system, or other such destination as discussed and suggested elsewhere herein.

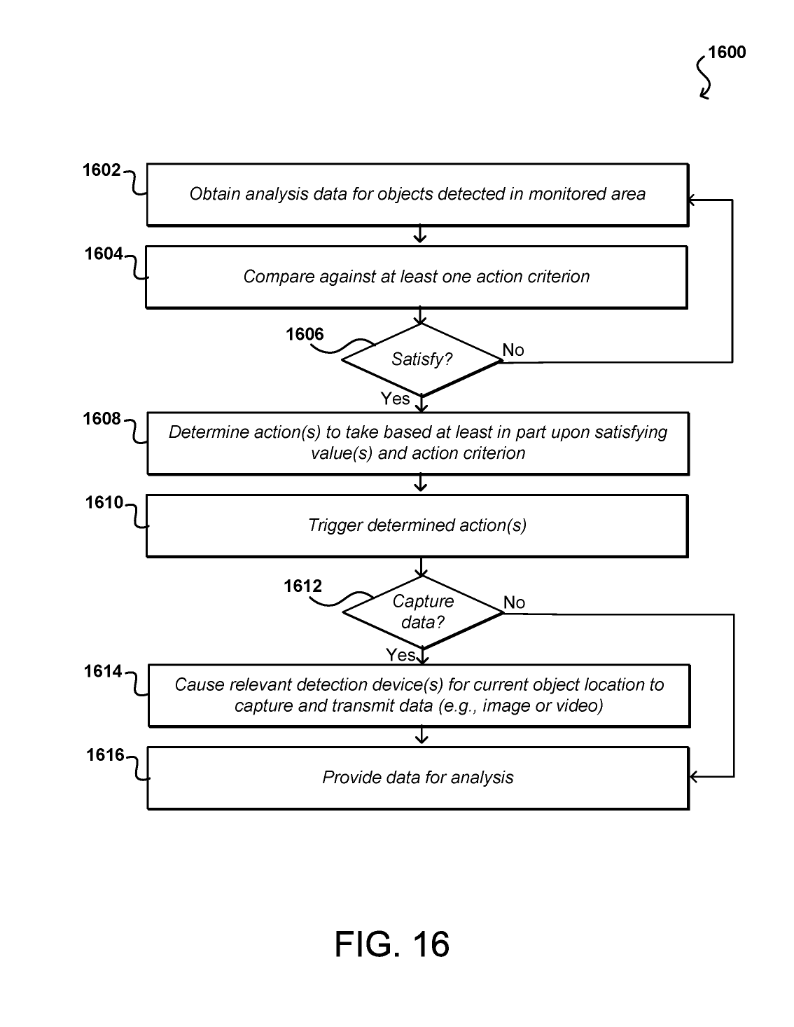

FIG. 16 illustrates an example process 1600 for taking action in response to the detection of objects or object behavior, using one or more detection devices, that can be utilized in accordance with various embodiments. In this example, the analysis data for objects detected in a monitored area can be obtained 1602, such as by using a process described with respect to FIG. 15 which includes object location and type information, among other such options. The analysis results can be compared 1604 against at least one action criterion, such as may relate to a type of object in a specific area, more than a specified number of objects of a specific type, and others discussed and suggested elsewhere herein. If it is determined 1606 that no action criteria are satisfied then the monitoring process can continue. If, however, at least one action criterion is satisfied for the monitored area, one or more actions to be taken can be determined 1608, which may depend at least in part upon which criterion was satisfied and the value that satisfied (or exceeded) the criterion. For example, in a store having more than a minimum number of people in the checkout area might trigger a request to have an additional checkout employee allocated, while detection of a person in an unauthorized area might trigger a security alarm, among other such possibilities. The determined action(s) can then be triggered 1610 by an appropriate system, service, or mechanism. The actions can be triggered automatically or manually in some embodiments, as well as combinations thereof. Another determination can be made 1612 as to whether additional data is to be captured for the object. In the security example, this might include capturing video data showing activity of the person in the restricted area. If so, the relevant detection device(s) can be caused to capture the additional data, as may include image, audio, and/or video, and store or transmit that data to a specified location or address. The data can then be provided 1616 for analysis as appropriate, such as may include displaying the information to a security personnel for real time review or storing for subsequent analysis. In some embodiments the additional captured data may be stored for subsequent use as evidence, for security review, or for other such purposes. Various other actions can be utilized as well within the scope of the various embodiments.

Client devices used to perform aspects of various embodiments can include any appropriate devices operable to send and receive requests, messages, or information over an appropriate network and convey information back to a user of the device. Examples of such client devices include personal computers, smart phones, handheld messaging devices, wearable computers, laptop computers, and the like. The network can include any appropriate network, including an intranet, the Internet, a cellular network, a local area network (LAN), or any other such network or combination thereof. Components used for such a system can depend at least in part upon the type of network and/or environment selected. Protocols and components for communicating via such a network are well known and will not be discussed herein in detail. Various aspects can be implemented as part of at least one service or Web service, such as may be part of a service-oriented architecture. In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any appropriate programming language.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
receiving object data from each of a plurality of detection devices, the detection devices including cameras operable to capture image data for a respective field of view and detect objects within the field of view, the object data including position data and descriptor data for each object represented in the object data, each set of object data corresponding to a respective image frame and including a respective timestamp;
correlating the object data from the plurality of detection devices based at least in part upon a relative orientation of each of the detection devices with respect to a region of interest, the correlating causing a determined object represented in object data from multiple devices to be treated as a single object based at least in part upon the respective position data from the multiple devices and the respective descriptor data for the determined object;
generating a mapping of the region of interest including a relative location of each object of interest in the region of interest and a determined type of each object of interest;
determining, using the mapping that at least one of count or position data for the objects of interest, with respect to the region of interest, satisfies an action criterion; and
triggering an action corresponding to the action criterion.

2. The computer-implemented method of claim 1, further comprising:
receiving subsequent object data from the plurality of detection devices at a subsequent point in time;
correlating objects of interest previously detected with objects of interest represented in the subsequent object data;
determining movement of the objects of interest based at least in part upon relative timestamps for the object data and the subsequent object data; and
providing information about patterns of movement of objects of specified types within the region of interest.

3. The computer-implemented method of claim 2, further comprising:
determining that at least one of the patterns of movement satisfies an action criterion; and
triggering an action corresponding to the action criterion.

4. The computer-implemented method of claim 1, further comprising:
sending, as part of the action, an instruction to at least a determined detection device, of the plurality of detection devices, to capture video data corresponding to the region of interest; and
receiving, in response, the video data, the detection device deleting the video data stored on the detection device after transmission.

5. The computer-implemented method of claim 1, wherein no personal information about the objects is transmitted with the object data or stored on the detection devices.

6. A computer-implemented method, comprising:
receiving, from at least one detection device, object data for a region of interest, the object data including position data and timestamp data for objects of at least one type detected in image data captured by the at least one detection device over a period of time;
correlating, based at least in part upon the position data, locations of a determined object, of the objects of the at least one type, over the period of time;
determining result data including at least one of a count or a position of objects of the at least one type in the region of interest over the time period; and
providing the result data for analysis.

7. The computer-implemented method of claim 6, further comprising:
receiving, with the object data, descriptor data for the objects of the at least one type, the descriptor data including values that can distinguish, but not identify, the objects; and
correlating the objects further based on the descriptor data.

8. The computer-implemented method of claim 6, wherein the descriptor data includes at least one of height, gender, age, length, paint color, clothing color, hair color, or pattern of movement.

9. The computer-implemented method of claim 6, further comprising:
correlating, based at least in part upon the position data and relative orientations of the at least one detection device, objects that are represented in object data from more than one detection device such that the object is analyzed as a single object in the region of interest over the period of time.

10. The computer-implemented method of claim 6, further comprising:
analyzing the result data using at least one action criterion;
determining that the result data satisfied a specified action criterion; and
triggering an action corresponding to the specified action criterion.

11. The computer-implemented method of claim 10, wherein the action includes at least one of adjusting a resource allocation, generating an alarm, alerting a designated party, or logging information for the result data.

12. The computer-implemented method of claim 6, further comprising:
determining the types of object of interest to be included in the object data;
determining a respective model for each type of object of interest, the respective models including patterns of feature points corresponding to objects of the respective type; and
providing the respective models to the at least one detection device, wherein the at least one detection device is configured to utilize the respective models to identify the objects of the representative types from captured image data.

13. The computer-implemented method of claim 6, further comprising:
determining a relative orientation of each of the at least one detection device;
determining a relative field of view for cameras of the at least one detection device; and
generating a coordinate mapping for object data generated by the at least one detection device using the relative orientation and relative field of view.

14. A system, comprising:
at least one processor; and
memory including instructions that, when executed by the at least one processor, cause the system to:
receive, from at least one detection device, object data for a region of interest, the object data including position data and timestamp data for objects of at least one type detected in image data captured by the at least one detection device over a period of time;
correlate, based at least in part upon the position data, locations of a determined object, of the objects of the at least one type, over the period of time;
determine result data including at least one of a count or a position of objects of the at least one type in the region of interest over the time period; and
provide the result data for analysis.

15. The system of claim 14, wherein the instructions when executed further cause the system to:
receive, with the object data, descriptor data for the objects of the at least one type, the descriptor data including values that can distinguish, but not identify, the objects; and
correlate the objects further based on the descriptor data.

16. The system of claim 14, wherein the instructions when executed further cause the system to:
correlate, based at least in part upon the position data and relative orientations of the at least one detection device, objects that are represented in object data from more than one detection device such that the object is analyzed as a single object in the region of interest over the period of time.

17. The system of claim 14, wherein the instructions when executed further cause the system to:
analyze the result data using at least one action criterion;
determine that the result data satisfied a specified action criterion; and
trigger an action corresponding to the specified action criterion, wherein the action includes at least one of adjusting a resource allocation, generating an alarm, alerting a designated party, or logging information for the result data.

18. The system of claim 14, wherein the instructions when executed further cause the system to:
determine the types of object of interest to be included in the object data;
determine a respective model for each type of object of interest, the respective models including patterns of feature points corresponding to objects of the respective type; and
provide the respective models to the at least one detection device, wherein the at least one detection device is configured to utilize the respective models to identify the objects of the representative types from captured image data.

19. The system of claim 14, wherein the instructions when executed further cause the system to:
determine a relative orientation of each of the at least one detection device;
determine a relative field of view for cameras of the at least one detection device; and
generate a coordinate mapping for object data generated by the at least one detection device using the relative orientation and relative field of view.

20. The system of claim 14, wherein the instructions when executed further cause the system to:
trigger a relocation of at least one of the detection devices based at least in part upon the result data.
